(19) United States
(12) Patent Application Publication
(10) Pub. No.: US 2026/0268009 A1
(43) Pub. Date: Sep. 10, 2026

(54) ELECTRONIC DEVICE FOR PERFORMING DATA CACHING BASED ON USER DATA PERMISSIONS AND OPERATING METHOD THEREOF

(71) Applicant: Samsung Electronics Co., Ltd., Suwon-si (KR)

(72) Inventors: Jooyoung JUNG, Suwon-si (KR); Minju KIM, Suwon-si (KR); Seungchul KO, Suwon-si (KR); Jehwan LEE, Suwon-si (KR)

(21) Appl. No.: 19/660,839

(22) Filed: Apr. 28, 2026

Related U.S. Application Data
(63) Continuation of application No. PCT/KR2024/016339, filed on Oct. 24, 2024.

(30) Foreign Application Priority Data
Dec. 12, 2023 (KR) 10-2023-0179924
Dec. 26, 2023 (KR) 10-2023-0191697

(51) Int. Cl. G06F 21/62; G06F 16/242

(52) U.S. Cl. CPC G06F 21/6218; G06F 16/2445

(57) ABSTRACT

An electronic device is provided. The electronic device includes memory, comprising one or more storage media, storing instructions; one or more processors communicatively coupled to the memory, wherein the instructions, when executed by the one or more processors individually or collectively, cause the electronic device to generate a token for managing data permissions of a user requesting a query, determine a cache type available to the user by using the query and the token, and request cache data corresponding to an execution result of the query based on the determined cache type, and wherein the instructions, when executed by the one or more processors individually or collectively, to determine the cache type further cause the electronic device to obtain job information about the query by executing a dry run of the query, and determine the cache type available to the user to be at least one of a user cache, a group cache, or a shared cache based on security information included in the job information, specific function information included in the query, and a type of the token.

### CROSS-REFERENCE TO RELATED APPLICATION(S)

This application is a continuation application, claiming priority under 35 U.S.C. § 365(c), of an International application No. PCT/KR2024/016339, filed on Oct. 24, 2024, which is based on and claims the benefit of a Korean patent application number 10-2023-0179924, filed on Dec. 12, 2023, in the Ministry of Intellectual Property (MOIP), and of a Korean patent application number 10-2023-0191697, filed on Dec. 26, 2023, in the MOIP, the disclosure of each of which is incorporated by reference herein in its entirety.

### BACKGROUND

### 1. Field

The disclosure relates to an electronic device for performing data caching based on user data permissions and an operating method thereof.

### 2. Description of Related Art

Data caching techniques may provide a quick response by storing results of data processing requests in the form of keys and values and providing previously acquired results for the same data processing request.

Typically, queries are widely used for data processing requests, and in systems that manage data based on permissions, user-level cache is supported because each user has different permission. User-level cache may cause various issues as the number of users increases.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device for performing data caching based on user data permissions and an operating method thereof.

Additional aspects will be set forth in part in the description which follows and, in part, will be apparent from the description, or may be learned by practice of the presented embodiments.

In accordance with an aspect of the disclosure, an electronic device is provided. The electronic device includes memory, comprising one or more storage media, storing instructions, one or more processors communicatively coupled to the memory, wherein the instructions, when executed by the one or more processors individually or collectively, cause the electronic device to generate a token for managing data permissions of a user requesting a query, determine a cache type available to the user by using the query and the token, and request cache data corresponding to an execution result of the query based on the determined cache type, and wherein the instructions, when executed by the one or more processors individually or collectively, to determine the cache type further cause the electronic device to obtain job information about the query by executing a dry-run of the query, and determine the cache type available to the user to be at least one of a user cache, a group cache, or a shared cache based on security information included in the job information, specific function information included in the query, and a type of the token.

In accordance with another aspect of the disclosure, a method of operating an electronic device is provided. The method includes generating a token for managing data permissions of a user requesting a query, determining a cache type available to the user by using the query and the token, and requesting cache data corresponding to an execution result of the query based on the determined cache type, wherein the determining of the cache type includes obtaining job information about the query by executing a dry-run of the query, and determining the cache type available to the user to be at least one of a user cache, a group cache, or a shared cache based on security information included in the job information, specific function information included in the query, and a type of the token.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include generating a token for managing data permissions of a user requesting a query, determining a cache type available to the user by using the query and the token, and requesting cache data corresponding to an execution result of the query based on the determined cache type, wherein the determining of the cache type includes obtaining job information about the query by executing a dry-run of the query, and determining the cache type available to the user to be at least one of a user cache, a group cache, or a shared cache based on security information included in the job information, specific function information included in the query, and a type of the token.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an electronic device in a network environment according to an embodiment of the disclosure;

FIG. 2 is a diagram illustrating an overall configuration of an electronic device for performing data caching based on user data permissions according to an embodiment of the disclosure;

FIG. 3 is a diagram illustrating a method of performing data caching based on user data permissions according to an embodiment of the disclosure;

FIG. 4 is a flowchart illustrating a detailed operation of a cache type manager according to an embodiment of the disclosure; and

FIG. 5 is a flowchart illustrating an operating method when a cache available to a user is a shared cache according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

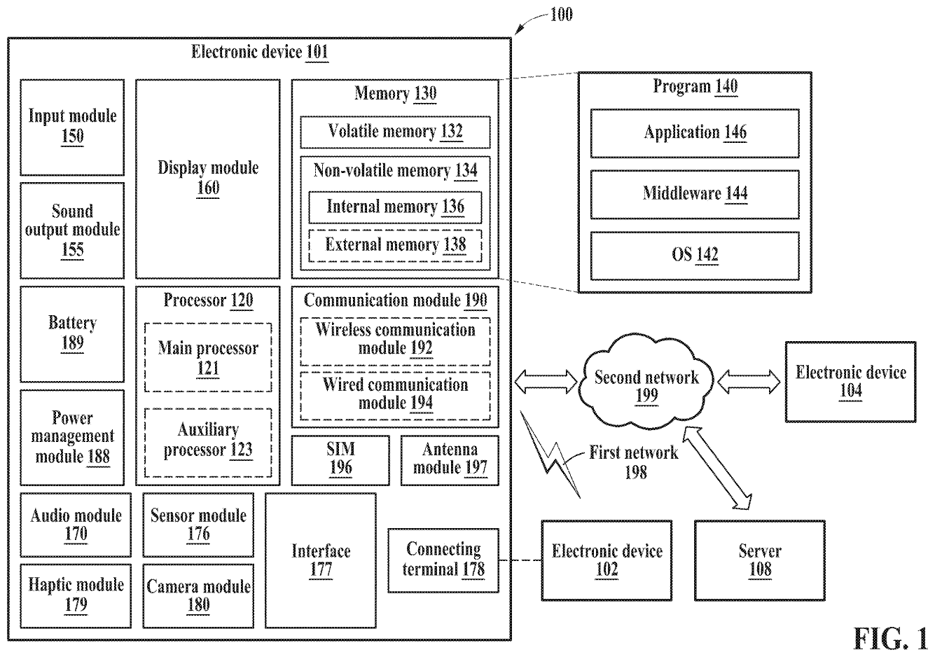

FIG. 1 is a block diagram illustrating an electronic device 101 in a network environment 100 according to an embodiment of the disclosure.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to another embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added to the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. As at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. The processor 120 may also be implemented as a system on chip (SoC) or an integrated circuit (IC) that performs processing. The processor 120 may include one or more processors, and operations of the electronic device 101 described in the disclosure may be performed by a single processor or by a combination of multiple processors. When the operations of the electronic device 101 are performed by a combination of multiple processors, any one processor included in the combination of processors may perform some of the operations of the electronic device 101.

According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. In an example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an ISP or a CP) may be implemented as part of another component (e.g., the camera module 180 or the communication module 190) functionally related to the auxiliary processor 123. According to another embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be, for example, a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network or a combination of two or more thereof, but is not limited thereto. The artificial intelligence model may, additionally or alternatively, include a software structure other than the hardware structure.

The memory 130 may be configured to store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134. The memory 130 may store at least one instruction executable by the processor 120. The memory 130 may include one or more memories, and instructions for controlling the processor 120 to perform operations of the electronic device 101 described in the disclosure may be stored in a single memory or may be divided and stored in multiple memories.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing a recording. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to another embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or an external electronic device (e.g., an electronic device 102 (e.g., a speaker or headphones) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. The sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

The connecting terminal 178 may include a connector via which the electronic device 101 may be physically connected with the external electronic device (e.g., the electronic device 102). According to another embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, ISPs, or flashes.

The power management module 188 may manage power supplied to the electronic device 101. According to another embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more CPs that are operable independently from the processor 120 (e.g., the AP) and support a direct (e.g., wired) communication or a wireless communication. The communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multiple components (e.g., multiple chips) separate from each other. The wireless communication module 192 may identify and authenticate the electronic device 101 in a communication network, such as the first network 198 or the second network 199, using subscriber information (e.g., international mobile subscriber identity (IMSI)) stored in the SIM 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include an antenna including a radiating element composed of a conductive material or a conductive pattern formed in or on a substrate (e.g., a printed circuit board (PCB)). According to another embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197. According to various embodiments, the antenna module 197 may form an mmWave antenna module. The mmWave antenna module may include a PCB, an RFIC disposed on a first surface (e.g., the bottom surface) of the PCB, or adjacent to the first surface and capable of supporting a designated high-frequency band (e.g., the mmWave band), and a plurality of antennas (e.g., array antennas) disposed on a second surface (e.g., the top or a side surface) of the PCB, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. All or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may, for example, perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an Internet-of-Things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspects (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). In an example, a processor (e.g., the processor 120) of the machine (e.g., the electronic device 101) may invoke at least one of the one or more instructions stored in the storage medium, and execute it. This allows the machine to be operated to perform at least one function according to the at least one instruction invoked. The one or more instructions may include code generated by a compiler or code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to other embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

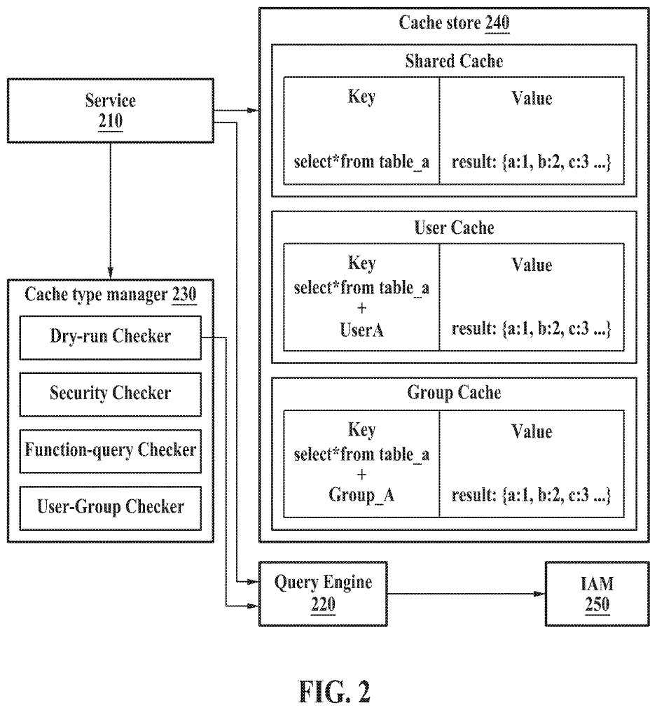

FIG. 2 is a diagram illustrating an overall configuration of an electronic device for performing data caching based on user data permissions according to an embodiment of the disclosure.

Referring to FIG. 2, one or more processors (e.g., the processor 120 of FIG. 1) included in an electronic device (e.g., the electronic device 101 of FIG. 1) may control an operation of a service 210, a query engine 220, a cache type manager 230, a cache store 240, and an identity and access management (IAM) system 250 to perform data caching based on user data permissions.

The service 210 may be a client or a server that uses the query engine 220. In an embodiment, when the service 210 receives a request for a query from a user, the service 210 may transmit a token for managing the user data permissions along with the query to the cache type manager 230 to determine a cache type available to the user. When the cache type available to the user is identified, the service 210 may request a result of the query from the cache store 240 based on the identified cache type. When the result of the query does not exist in the cache store 240, the service 210 may request the query from the query engine 220.

The query engine 220 may use the IAM 250 to determine the user data permissions. The query engine 220 may determine whether to perform the query requested by the user based on the user data permissions determined by the IAM 250. The query engine 220 may support row-level security, column-level security, or dry-run. For example, the query engine 220 may be Google Cloud Platform (GCP) (BigQuery) or Azure (Synapse Analytics), but the type of the query engine 220 is only an example and is not limited thereto.

The cache type manager 230 may determine the cache type available to the user to be at least one of a user cache, a group cache, or a shared cache. The cache type manager 230 may include at least one checker among a dry-run checker, a security checker, a function-query checker, and a user-group checker.

The dry-run checker may obtain permissions and information about the query by executing a dry-run or a query plan using the query engine 220 to check the user data permissions for the query requested by the user. In an embodiment, when the user data permissions for the query are valid and the query is valid, the dry-run checker may obtain information about the successfully executed dry-run or query plan from the query engine 220. Here, a unit that executes the query in the query engine 220 may be displayed as a job, and information about the job may be displayed as job information. The job information may include security information about data (e.g., tables) referenced by the query.

The security checker may perform a function of determining the job information received from the query engine 220 when the dry-run or the query plan executed by the query engine 220 is successfully executed. More specifically, the security checker may determine whether row-level security is applied to the table referenced by the query based on the security information included in the job information. The row-level security may have a characteristic of having user-specific permissions at the row level, so that the query execution results are different for each user. Therefore, the security checker may determine a cache available to the corresponding user to be a user cache when the table referenced by the query has row-level security applied.

In another example, the security checker may determine whether masking is applied to the table referenced by the query based on the security information included in the job information. The security checker may determine the cache available to the user to be a user cache when the table referenced by the query has masking applied.

The security checker may determine a special case in which the user data permissions after a dry-run are distinguished according to the query engine 220, and may determine a cache available to the user based on the determined case.

The function-query checker may determine whether a structured query language (SQL) statement corresponding to the query received from the service 210 includes specific function information. The function-query checker may determine the cache available to the user to be a user cache when the SQL statement includes the specific function information.

The specific function information may include a time-related function that changes for each operation. In addition, the specific function information may include a universally unique identifier (UUID) generation function, a random value generation function, or a current user identification function. The specific function information may vary depending on the characteristics supported by each query engine 220.

In an example, the specific function information may include the following functions, which are commonly used nondeterministic functions.
(i) CURRENT_DATE: a function that returns a current time in Date format.
(ii) CURRENT_DATETIME: a function that returns a current time in DateTime format.
(iii) CURRENT_TIME: a function that returns a current time in Time format.
(iv) CURRENT_TIMESTAMP: a function that returns a current time in Timestamp format.
(v) GENERATE_UUID: a function that randomly generates a UUID.
(vi) RAND: a function that generates a random value.
(vii) SESSION_USER: a function that obtains a current user.
(viii) ST_GEOGPOINT: a function that generates a point used in geography.

However, the functions included in the specific function information described above are only an example and are not limited thereto.

The user-group checker may determine whether the token received from the service 210 is a token of a specific group. When it is determined that the token belongs to a specific group, the user-group checker may determine the cache available to the user to be a group cache. A decision logic of a group cache may determine whether to use the group cache or not based on a group usage policy. Typically, the user-group checker may receive group information from the IAM 250 and process the decision logic of the group cache, and may also process the decision logic of the group cache using a group-related mapping table stored internally in the service 210.

The cache store 240 may store an execution result of the query derived through the query engine 220 as cache data, and when cache data is requested from the service 210, the requested cache data may be provided to the service 210. For example, the cache store 240 may be Remote Dictionary Storage (Redis) or Memcached, but the type of the cache store 240 is only an example and is not limited thereto.

The cache store 240 may store cache data by determining the cache data to be at least one of a shared cache, a user cache, and a group cache. The shared cache may include cache data that is commonly available to all users. Here, the shared cache may use a query statement as a key value and store the query execution result as a value. The user cache may include cache data that is private to individual users. Here, the user cache may use a query statement and user identification information as key values, and store the query execution result as a value. The group cache may include cache data that is commonly available to a specific group of users. Here, the group cache may use a query statement and group identification information as key values, and store the query execution result as a value.

The IAM 250 may identify, based on the token received from the service 210, whether the token represents data permissions for a specific user or whether the token represents data permissions for a specific group.

The electronic device 101 may include the one or more processors 120, and the one or more memories 130 that store instructions executable by the one or more processors 120. When at least some of the instructions stored in the one or more memories 130 are executed by the one or more processors 120, the at least some of the instructions may cause the electronic device 101 (or the one or more processors 120) to perform the following operations.

According to an embodiment, the electronic device 101 may generate a token for managing data permissions of a user who requests a query. The electronic device 101 may determine a cache type available to the user by using the query and the token. The electronic device 101 may request cache data corresponding to an execution result of the query based on the determined cache type.

The determining of the cache type may include receiving job information about the query by executing a dry-run of the query. The determining of the cache type may include determining the cache type available to the user to be at least one of a user cache, a group cache, or a shared cache based on security information included in the job information, specific function information included in the query, and a type of the token.

In an embodiment, the determining of the cache type may include identifying whether a table referenced by the query is a table to which row-level security is applied, based on the security information included in the job information. The determining of the cache type may include determining the cache available to the user to be a user cache when the table referenced by the query is identified as a table to which row-level security is applied.

The determining of the cache type may include identifying whether masking is applied to the table referenced by the query based on the security information included in the job information. The determining of the cache type may include determining the cache available to the user to be a user cache when masking is applied to the table referenced by the query.

In an embodiment, the determining of the cache type may include identifying whether the token for managing the data permissions of the user is a token of a specific group. The determining of the cache type may include determining the cache available to the user to be a group cache when the token is identified as a token of a specific group.

In another embodiment, the determining of the cache type may include identifying whether an SQL statement corresponding to the query includes specific function information. The determining of the cache type may include determining the cache available to the user to be a user cache when it is identified that the SQL statement includes specific function information.

According to an embodiment, the specific function information may include at least one of a time-related function using the current time, a UUID generation function, a random value generation function, or a current user identification function.

According to another embodiment, the determining of the cache type may include determining the cache available to the user to be a shared cache when the cache type determined based on the security information included in the task information, the specific function information included in the query, and the type of the token is not a user cache or a group cache.

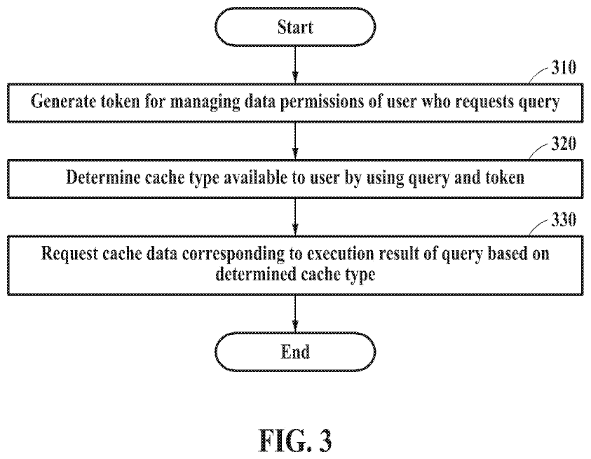

FIG. 3 is a diagram illustrating a method of performing data caching based on user data permissions according to an embodiment of the disclosure. In an embodiment, at least one of the operations of FIG. 3 may be performed simultaneously or in parallel with other operations, and the order between operations may be changed. Additionally, at least one of the operations may be omitted, and other operations may be additionally performed. The operations illustrated in FIG. 3 may be performed by at least one component of an electronic device (e.g., the electronic device 101 of FIG. 1).

In operation 310, the electronic device 101 may generate a token for managing data permissions of a user who requests a query. In operation 320, the electronic device 101 may determine a cache type available to the user by using the query and the token. In operation 330, the electronic device 101 may request cache data corresponding to an execution result of the query based on the determined cache type.

In an embodiment, the determining of the cache type may include obtaining job information about the query by executing a dry-run of the query. The determining of the cache type may include determining the cache type available to the user to be at least one of a user cache, a group cache, or a shared cache based on security information included in the job information, specific function information included in the query, and a type of the token.

In an embodiment, the determining of the cache type may include identifying whether a table referenced by the query is a table to which row-level security is applied, based on the security information included in the job information. The determining of the cache type may include determining the cache available to the user to be a user cache when the table referenced by the query is identified as a table to which row-level security is applied.

The determining of the cache type may include identifying whether masking is applied to the table referenced by the query based on the security information included in the job information. The determining of the cache type may include determining the cache available to the user to be a user cache when masking is applied to the table referenced by the query.

In an embodiment, the determining of the cache type may include identifying whether the token for managing the data permissions of the user is a token of a specific group. The determining of the cache type may include determining the cache available to the user to be a group cache when the token is identified as a token of a specific group. the determining of the cache type may include identifying whether an SQL statement corresponding to the query includes specific function information. The determining of the cache type may include determining the cache available to the user to be a user cache when it is identified that the SQL statement includes specific function information.

According to an embodiment, the specific function information may include at least one of a time-related function using the current time, a UUID generation function, a random value generation function, or a current user identification function.

The determining of the cache type may include determining the cache available to the user to be a shared cache when the cache type determined based on the security information included in the task information, the specific function information included in the query, and the type of the token is not a user cache or a group cache.

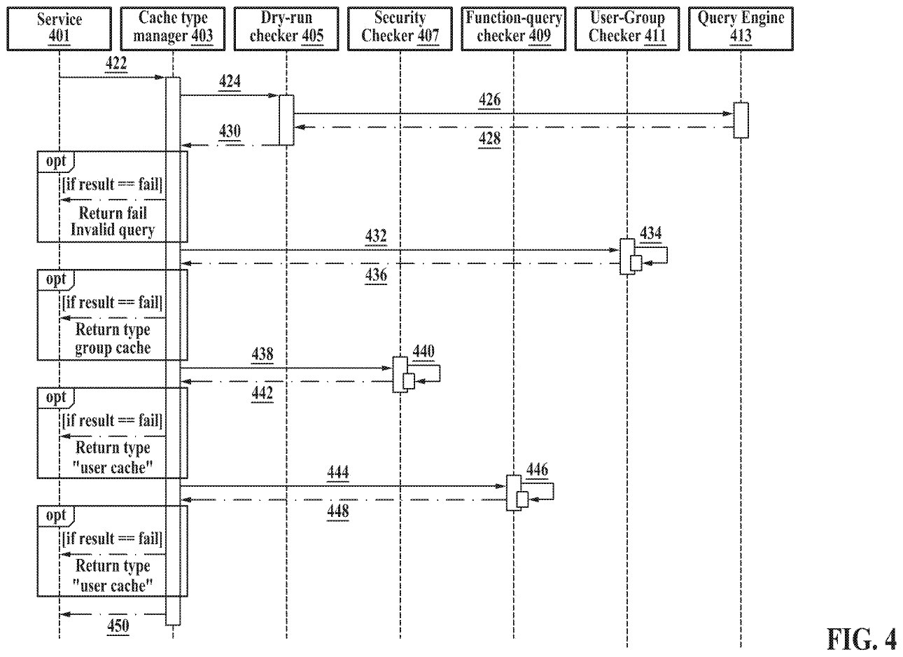

FIG. 4 is a flowchart illustrating a detailed operation of a cache type manager according to an embodiment of the disclosure. In an embodiment, at least one of the operations of FIG. 4 may be performed simultaneously or in parallel with other operations, and the order between operations may be changed. Additionally, at least one of the operations may be omitted, and other operations may be additionally performed. The operations illustrated in FIG. 4 may be performed by at least one component of an electronic device (e.g., the electronic device 101 of FIG. 1).

Referring to FIG. 4, when a query requested by a user is received, a service 401 may transmit 422 a request for a cache type to a cache type manager 403. Here, the service 401 may transmit a token for managing data permissions of the user along with the received query of the user to the cache type manager 403. Ina an example, when the user requesting the query is an individual user, the service 401 may transmit a user token to the cache type manager 403. In another example, when the user requesting the query is a user included in a specific group, the service 401 may transmit a group token to the cache type manager 403.

The cache type manager 403 may transmit 424 a request for a dry-run to a dry-run checker 405. When the request for a dry-run is received, the dry-run checker 405 may execute 426 a dry-run of the query using a query engine 413. Here, when the dry-run is successful, the query engine 413 may return/respond 428 with job information to the dry-run checker 405. The query engine 413 may return/respond 428 an error message corresponding to failure to the dry-run checker 405 when the query is invalid or the user's data permissions for a table referenced by the query are invalid. The dry-run checker 405 may transmit 430 an execution result of the dry-run to the cache type manager 403. Here, when the cache type manager 403 identifies that the dry-run has failed based on the execution result, the cache type manager 403 may transmit the execution result of the dry-run related to the failure to the service 401.

When the dry-run is successful and job information is received from the query engine 413, the cache type manager 403 may request 432 a user-group checker 411 to determine whether the token received from the service 401 is a token of a specific group. The user-group checker 411 may determine 434 whether the token received from the service 401 is a token of a specific group and transmit 436 the determination result to the cache type manager 403. Here, when the cache type manager 403 identifies that the token received from the service 401 is a token of a specific group based on the determination result, the cache type manager 403 may determine the cache available to the user to be a group cache and then transmit the determined cache type to the service 401.

When the token received from the service 401 is determined not to be a token of a specific group, the cache type manager 403 may request 438 a determination on security information from a security checker 407. The security checker 407 may determine 440 whether a table referenced by the query is a table to which row-level security is applied based on security information included in the job information, and may transmit 442 the determination result to the cache type manager 403. Here, when the cache type manager 403 identifies that the table referenced by the query is a table to which row-level security is applied based on the determination result, the cache type manager 403 may determine the cache available to the user to be a user cache and then transmit the determined cache type to the service 401.

In another example, the security checker 407 may determine 440 whether masking is applied to the table referenced by the query based on the security information included in the job information, and transmit 442 the determination result to the cache type manager 403. Here, when the cache type manager 403 identifies that masking is applied to the table referenced by the query based on the determination result, the cache type manager 403 may determine the cache available to the user to be a user cache and then transmit the determined cache type to the service 401.

Based on the determination on the security information, when it is determined that the cache available to the user is not a user cache, the cache type manager 403 may request 444 a function-query checker 409 to determine whether specific function information is included in an SQL statement corresponding to the query received from the service 401. The function-query checker 409 may determine 446 whether specific function information is included in the SQL statement and transmit 448 the determination result to the cache type manager 403. Here, when the cache type manager 403 identifies that the SQL statement includes the specific function information based on the determination result, the cache type manager 403 may determine the cache available to the user to be a user cache and then transmit the determined cache type to the service 401.

When the cache type determined based on the security information included in the job information, the specific function information included in the query, and the type of the token is not a user cache or a group cache, the cache type manager 403 may determine the cache available to the user to be a shared cache and then transmit 450 the determined cache type to the service 401.

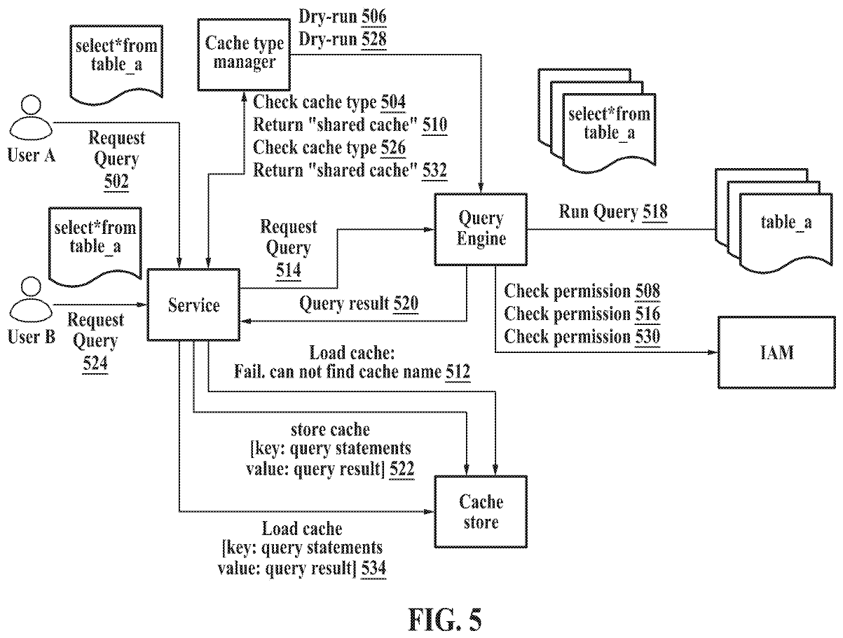

FIG. 5 is a flowchart illustrating an operating method when a cache available to a user is a shared cache according to an embodiment of the disclosure.

In an embodiment, at least one of the operations of FIG. 5 may be performed simultaneously or in parallel with other operations, and the order between operations may be changed. Additionally, at least one of the operations may be omitted, and other operations may be additionally performed. The operations illustrated in FIG. 5 may be performed by at least one component of an electronic device (e.g., the electronic device 101 of FIG. 1).

When a first user (e.g., User A of FIG. 5) requests 502 a query from a service, the service may request 504 a cache type from a cache type manager. The cache type manager may execute 506 a dry-run of the query using a query engine. The query engine may check 508 data permissions for a table referenced by the query through an IAM.

The cache type manager may return 510 a shared cache, which is a cache available to the user determined based on a cache type decision logic, to the service, and the service may request 512 cache data corresponding to an execution result of the query from a cache store by using a query statement as a key value. However, in this example, an error message corresponding to a failure may be received by the service when the key value does not exist. The service may request 514 the query from the query engine since there is no cache data corresponding to the query in the cache store. The query engine may check 516 the data permissions for the table referenced by the query through the IAM, and when the data permissions are determined as valid, the query may be executed 518. The query engine may transmit 520 the execution result of the query to the service, and the service may store 522 the execution result of the query received from the query engine in the cache store. Here, the cache store may use the query statement as a key value and store the execution result of the query as a value, since the cache available to the user is a shared cache.

When a new second user (e.g., User B of FIG. 5) requests 524 the same query as the first user, the service may request 526 a cache type from the cache type manager. The cache type manager may execute 528 a dry-run of the query using the query engine. The query engine may check 530 data permissions for a table referenced by the query through the IAM.

The cache type manager may return 532 a shared cache, which is a cache available to the user determined based on a cache type decision logic, to the service, and the service may request 534 cache data corresponding to the execution result of the query from the cache store by using the query statement as a key value. In this case, the cache store may respond with a value (an execution result of the query) corresponding to the key value requested from the service when previously stored cache data is before an expiration time based on the expiration time of the cache data.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
memory, comprising one or more storage media, storing instructions; and
one or more processors communicatively coupled to the memory,
wherein the instructions, when executed by the one or more processors individually or collectively, cause the electronic device to:
generate a token for managing data permissions of a user requesting a query,
determine a cache type available to the user by using the query and the token, and
request cache data corresponding to an execution result of the query based on the determined cache type, and
wherein the instructions, when executed by the one or more processors individually or collectively, to determine the cache type further cause the electronic device to:
obtain job information about the query by executing a dry-run of the query, and
determine the cache type available to the user to be at least one of a user cache, a group cache, or a shared cache based on security information included in the job information, specific function information included in the query, and a type of the token.

2. The electronic device of claim 1, wherein the instructions, when executed by the one or more processors individually or collectively to determine the cache type, further cause the electronic device to:
identify whether a table referenced by the query is a table to which row-level security is applied based on the security information included in the job information, and
in response to the table referenced by the query being identified as a table to which row-level security is applied, determine a cache available to the user to be a user cache.

3. The electronic device of claim 2, wherein the instructions, when executed by the one or more processors individually or collectively to determine the cache type, further cause the electronic device to:
identify whether masking is applied to the table referenced by the query based on the security information included in the job information, and
in response to masking being applied to the table referenced by the query, determine the cache available to the user to be a user cache.

4. The electronic device of claim 3, wherein the instructions, when executed by the one or more processors individually or collectively to determine the cache type, further cause the electronic device to:
identify whether the token for managing the data permissions of the user is a token of a specific group, and
in response to the token being identified as a token of a specific group, determine the cache available to the user to be a group cache.

5. The electronic device of claim 4, wherein the instructions, when executed by the one or more processors individually or collectively to determine the cache type, further cause the electronic device to:
identify whether a structured query language (SQL) statement corresponding to the query includes specific function information, and
in response to identifying that the SQL statement includes specific function information, determine the cache available to the user to be a user cache.

6. The electronic device of claim 5, wherein the specific function information comprises at least one of:
a time-related function using a current time,
a universally unique identifier (UUID) generation function,
a random value generation function, or
a current user identification function.

7. The electronic device of claim 6, wherein the instructions, when executed by the one or more processors individually or collectively to determine the cache type, further cause the electronic device to:
in response to the cache type determined based on the security information included in the job information, the specific function information included in the query, and the type of the token not being a user cache or a group cache, determine the cache available to the user to be a shared cache.

8. A method of operating an electronic device, the method comprising:
generating a token for managing data permissions of a user requesting a query;
determining a cache type available to the user by using the query and the token; and
requesting cache data corresponding to an execution result of the query based on the determined cache type,
wherein the determining of the cache type includes:
obtaining job information about the query by executing a dry-run of the query; and
determining the cache type available to the user to be at least one of a user cache, a group cache, or a shared cache based on security information included in the job information, specific function information included in the query, and a type of the token.

9. The method of claim 8, wherein the determining of the cache type comprises:
identifying whether a table referenced by the query is a table to which row-level security is applied based on the security information included in the job information; and
in response to the table referenced by the query being identified as a table to which row-level security is applied, determining a cache available to the user to be a user cache.

10. The method of claim 9, wherein the determining of the cache type comprises:
identifying whether masking is applied to the table referenced by the query based on the security information included in the job information; and
in response to masking being applied to the table referenced by the query, determining the cache available to the user to be a user cache.

11. The method of claim 10, wherein the determining of the cache type comprises:
identifying whether the token for managing the data permissions of the user is a token of a specific group; and
in response to the token being identified as a token of a specific group, determining the cache available to the user to be a group cache.

12. The method of claim 11, wherein the determining of the cache type comprises:
identifying whether a structured query language (SQL) statement corresponding to the query includes specific function information; and
in response to identifying that the SQL statement includes specific function information, determining the cache available to the user to be a user cache.

13. The method of claim 12, wherein the specific function information comprises at least one of:
a time-related function using a current time,
a universally unique identifier (UUID) generation function,
a random value generation function, or
a current user identification function.

14. The method of claim 13, wherein the determining of the cache type comprises:
in response to the cache type determined based on the security information included in the job information, the specific function information included in the query, and the type of the token not being a user cache or a group cache, determining the cache available to the user to be a shared cache.

15. One or more non-transitory computer-readable storage media storing one or more computer programs including computer-executable instructions that, when executed by one or more processors of an electronic device individually or collectively, cause the electronic device to perform operations, the operations comprising:
generating a token for managing data permissions of a user requesting a query;
determining a cache type available to the user by using the query and the token; and
requesting cache data corresponding to an execution result of the query based on the determined cache type,
wherein the determining of the cache type includes:
obtaining job information about the query by executing a dry-run of the query; and
determining the cache type available to the user to be at least one of a user cache, a group cache, or a shared cache based on security information included in the job information, specific function information included in the query, and a type of the token.

16. The one or more non-transitory computer-readable storage media of claim 15, wherein the determining of the cache type comprises:
identifying whether a table referenced by the query is a table to which row-level security is applied based on the security information included in the job information; and
in response to the table referenced by the query being identified as a table to which row-level security is applied, determining a cache available to the user to be a user cache.

17. The one or more non-transitory computer-readable storage media of claim 16, wherein the determining of the cache type comprises:
identifying whether masking is applied to the table referenced by the query based on the security information included in the job information; and
in response to masking being applied to the table referenced by the query, determining the cache available to the user to be a user cache.

18. The one or more non-transitory computer-readable storage media of claim 17, wherein the determining of the cache type comprises:
identifying whether the token for managing the data permissions of the user is a token of a specific group; and
in response to the token being identified as a token of a specific group, determining the cache available to the user to be a group cache.

19. The one or more non-transitory computer-readable storage media of claim 18, wherein the determining of the cache type comprises:
identifying whether a structured query language (SQL) statement corresponding to the query includes specific function information; and
in response to identifying that the SQL statement includes specific function information, determining the cache available to the user to be a user cache.

20. The one or more non-transitory computer-readable storage media of claim 19, wherein the specific function information comprises at least one of:
a time-related function using a current time,
a universally unique identifier (UUID) generation function,
a random value generation function, or
a current user identification function.
